(19) United States
(12) Patent Application Publication
(10) Pub. No.: US 2026/0358476 A1
(43) Pub. Date: Nov. 12, 2026

(54) VEHICLE SYSTEM COMPRISING A MODULE FOR RECEIVING A LIGHT BEAM

(71) Applicant: VALEO VISION, Bobigny (FR)

(72) Inventors: Pierre RENAUD, Bobigny (FR); Mickael MIMOUN, Bobigny (FR); Sidahmed BEDDAR, Bobigny (FR); Matheo GOURDON, Bobigny (FR); Geoffrey PIQUARD, Bobigny (FR)

(73) Assignee: VALEO VISION, Bobigny (FR)

(21) Appl. No.: 19/140,141

(22) PCT Filed: Dec. 19, 2023
(86) PCT No.: PCT/EP2023/086499

§ 371 Date: Jun. 17, 2025

(30) Foreign Application Priority Data
Dec. 20, 2022 (FR) FR2213958

(51) Int. Cl. G01S 7/481; G01S 17/88

(52) U.S. Cl. CPC G01S 7/4816; G01S 17/88

(57) ABSTRACT

The invention relates to a system for a vehicle. The system includes a module for receiving a light beam. The receiving module includes at least one photodetector. The receiving module also includes at least two optical elements configured to receive the light beam, the light beam resulting from an initial light beam generated by an emitting module, block the light beam in a first wavelength range and in a second wavelength range, and transmit the light beam to the at least one photodetector in a wavelength range between 435 and 455 nanometers. The at least one photodetector is arranged so as to have a maximum sensitivity at blue wavelengths and is configured to receive the light beam in the wavelength range and to convert it into a corresponding electrical signal.

### TECHNICAL FIELD

The present invention relates to a vehicle system comprising a module for receiving a light beam. It is particularly, but non-limitingly, applicable to detection of a target object located in front of a motor vehicle, or even to transmission of data from one motor vehicle to another or from one motor vehicle to a piece of road infrastructure.

### BACKGROUND OF THE INVENTION

In the field of motor vehicles, one vehicle system known to those skilled in the art comprises a module for receiving a light beam that comprises at least one photodetector, the latter being configured to convert the light beam into a corresponding electrical signal. In the context of detection of a target object, a computing unit is configured to detect the presence or absence of a target object based on the electrical signal transmitted by said at least one photodetector. In the context of transmission of data, a computing unit is configured to detect the data transmitted based on the electrical signal transmitted by said at least one photodetector.

One drawback of the prior art is that, under certain conditions, the photodetector may see its signal-to-noise ratio degrade greatly. This is in particular the case under bright sunshine or bright ambient light. Specifically, under such conditions, the sunlight or ambient light may lead to saturation of the photodetector. The electrical signal (containing the information required to detect a target object or to communicate with another vehicle or with a piece of road infrastructure) transmitted by the photodetector will be drowned in the noise generated by the sunlight or ambient light.

### SUMMARY OF THE INVENTION

In this context, the present invention is intended to provide a vehicle system configured to allow the aforementioned drawback to be overcome.

To this end, the invention provides a vehicle system comprising:
a module for receiving a light beam, said receiving module comprising at least one photodetector,

characterized in that:
(a) said receiving module further comprises at least two optical elements configured to:
receive said light beam, said light beam resulting from an initial light beam generated by an emitting module;
block said light beam in a first wavelength range and in a second wavelength range; and
transmit said light beam to said at least one photodetector in a wavelength range between 435 and 455 nanometers,

and in that:
(b) said at least one photodetector is arranged so as to have a maximum sensitivity at blue wavelengths and is configured to receive said light beam in said wavelength range (LP) and to convert it into a corresponding electrical signal.

Thus, as will be seen in detail below, combination of filtering by the two optical elements and of use of a photodetector that is insensitive to infrared makes it possible to increase the signal-to-noise ratio of the light beam, the noise being sunlight.

According to non-limiting embodiments, said vehicle system may further comprise, alone or in any technically possible combination, one or more additional features selected from the following.

According to one non-limiting embodiment, said at least one detector comprises a PN junction with a bandgap of between 3 electronvolts and 2.5 electronvolts.

According to one non-limiting embodiment,
one of the optical elements comprises a first lens and an associated low-pass filter that is configured to block the light beam in the first wavelength range, and
the other of the optical elements comprises a second lens and an associated high-pass filter that is configured to block the light beam in the second wavelength range.

According to one non-limiting embodiment,
one of the optical elements is a first lens having a high-pass spectral absorption property configured to block the light beam in the first wavelength range, and
the other of the optical elements is a second lens having a low-pass spectral absorption property configured to filter the light beam in the second wavelength range.

According to one non-limiting embodiment, the first wavelength range is between 455 nanometers and 650 nanometers.

According to one non-limiting embodiment, the second wavelength range is between 380 nanometers and 435 nanometers.

According to one non-limiting embodiment, said system further comprises an emitting module (10) comprising a luminous module configured to emit said initial light beam partly in the visible.

According to one non-limiting embodiment, said emitting module further comprises a modulating unit configured to generate a modulated signal for controlling the emission of said initial light beam.

According to one non-limiting embodiment, said luminous module comprises at least one light source configured to emit said initial light beam with a view to performing a photometric lighting and/or signaling or daytime-running-light function.

According to one non-limiting embodiment, said emitting module forms part of a headlamp or tail lamp of said vehicle.

According to one non-limiting embodiment, said light beam is a light beam reflected from at least one target object located in a field of view of said initial light beam.

According to one non-limiting embodiment, said receiving module further comprises a demodulating unit configured to demodulate the electrical signal and to transmit said demodulated electrical signal to a computing unit, and said computing unit is configured, based on said demodulated electrical signal, to correlate said demodulated electrical signal and said modulated signal in order to deduce therefrom the presence of said at least one target object.

According to one non-limiting embodiment, said emitting module forms part of another vehicle or of a piece of road infrastructure.

According to one non-limiting embodiment, said light beam transports a data sequence.

According to one non-limiting embodiment, said receiving module further comprises a demodulating unit configured to demodulate the electrical signal and to extract therefrom said data sequence with a view to using it for communication with said other vehicle or said piece of road infrastructure.

### BRIEF DESCRIPTION OF DRAWINGS

The invention and its various applications will be better understood from reading the following description and examining the accompanying figures:

FIG. 1 illustrates a schematic architecture of a vehicle system according to a first non-limiting embodiment of the invention, said system comprising a receiving module with at least two optical elements and at least one photodetector, said receiving module being configured to receive a light beam resulting from an initial light beam of an emitting module, the latter forming part of said system,

FIG. 2 illustrates a schematic architecture of a vehicle system according to a second non-limiting embodiment of the invention, said system comprising a receiving module with at least two optical elements and at least one photodetector, said receiving module being configured to receive a light beam resulting from an initial light beam of an emitting module, the latter being external to said system,

FIG. 3 illustrates a schematic architecture of said at least two optical elements of the receiving module of FIG. 1 or FIG. 2, according to a first non-limiting embodiment,

FIG. 4 illustrates a schematic architecture of said at least two optical elements of the receiving module of FIG. 1 or FIG. 2, according to a second non-limiting embodiment,

FIG. 5 schematically illustrates a PN junction of said at least one photodetector of FIG. 3 or FIG. 4, according to one non-limiting embodiment, and

FIG. 6 schematically and partially illustrates an intensity spectrum of the light of a light beam generated by the receiving module of FIG. 1 or FIG. 2, said intensity spectrum being superposed on a solar irradiance spectrum.

### DETAILED DESCRIPTION OF THE INVENTION

Elements that are identical, in structure or in function, and that appear in various figures have been designated by the same reference signs in all of them, unless specified otherwise.

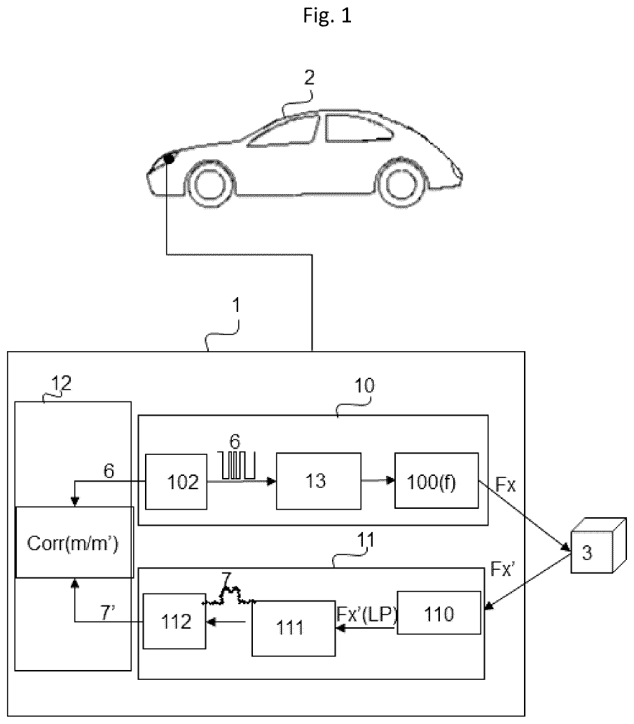

The vehicle detecting system 1 according to the invention will now be described with reference to FIGS. 1 to 6. In one non-limiting embodiment, the vehicle 2 is a motor vehicle. By motor vehicle, what is meant is any type of combustion or electric vehicle. This embodiment is considered, by way of non-limiting example, in the remainder of the description. In the remainder of the description, the vehicle 2 is thus also called motor vehicle 2.

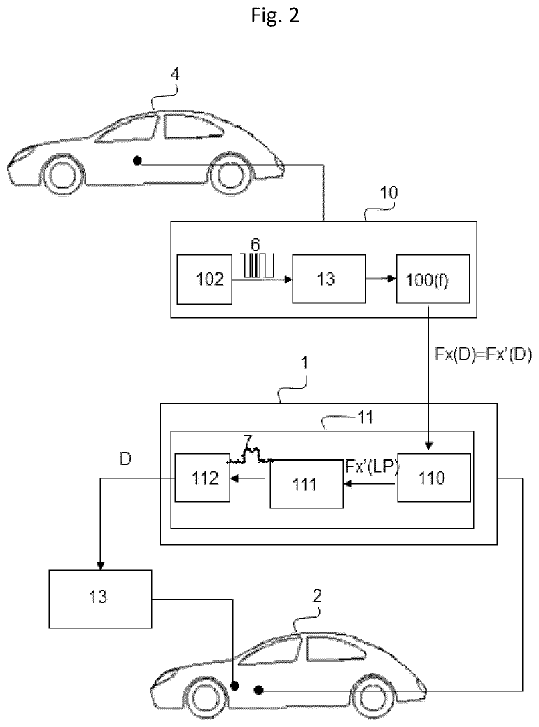

As illustrated in FIGS. 1 and 2, the system 1 comprises a receiving module 11.

In a first non-limiting embodiment illustrated in FIG. 1, the system 1 further comprises an emitting module 10. In this case, the receiving module 11 and the emitting module 10 form part of a headlamp or tail lamp of the motor vehicle 2. In this case, in one non-limiting example, the system 1 is used to detect a target object 3.

In a second non-limiting embodiment illustrated in FIG. 2, the system 1 does not comprise the emitting module 10. In this case, the emitting module 10 forms part of another vehicle 4 or of a piece of road infrastructure (not illustrated). In this case, in one non-limiting example, the system 1 is used to transmit data from the motor vehicle 2 to another vehicle 4 or to a piece of road infrastructure. In FIG. 2, the non-limiting example of another vehicle 4 has been illustrated. It may be replaced by a piece of road infrastructure.

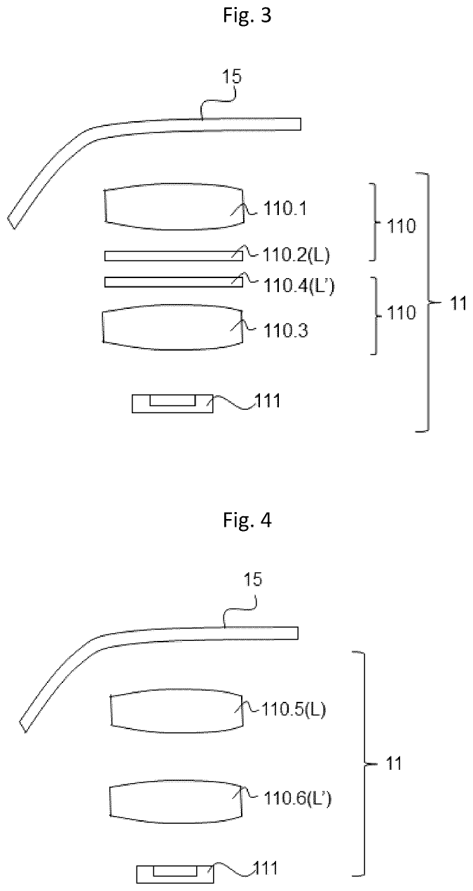

In one non-limiting embodiment, the headlamp or tail lamp comprises an outer lens 15 (illustrated in FIGS. 3 and 4). In one non-limiting embodiment, the outer lens 15 comprises an anti-UV treatment to block the UV (between 300 and 400 nanometers) of sunlight.

The emitting module 10 will be described below.

The emitting module 10 comprises a luminous module 100 configured to emit an initial light beam Fx partly in the visible (which has a blue, yellow and red component). The initial light beam Fx makes it possible to perform a photometric function called function f. In one non-limiting embodiment, the photometric function is a lighting and/or signaling or daytime-running-light function.

In order to emit the initial light beam Fx, the luminous module 100 comprises at least one light source 100.1 configured to emit light rays with a view to forming said initial light beam Fx. The light rays are blue and yellow light rays, the light thus formed being visible light that appears white to the human eye. The blue light rays may be converted into infrared light rays by means known to those skilled in the art.

Thus, the initial light beam Fx emitted by the light source 100.1 thus has an electromagnetic spectrum with at least one segment located in the visible spectrum, the remainder being in the infrared. The electromagnetic spectrum has an intensity peak B1 in the blue (illustrated in FIG. 6). It has other smaller intensity peaks in the visible and infrared.

In one non-limiting embodiment, the light source 100.1 is a semiconductor light source. In one non-limiting embodiment, said semiconductor light source forms part of a light-emitting diode. By light-emitting diode, what is meant is any type of light-emitting diode, such as, to give non-limiting examples, conventional LEDs (Light-Emitting Diodes), OLEDs (Organic LEDs), AMOLEDs (Active-Matrix-Organic LEDs), or even FOLEDs (Flexible OLEDs). In other non-limiting embodiments, said light source 100.1 is a laser source such as a VCSEL (Vertical-Cavity Surface-Emitting Laser) or indeed a SLED laser diode (Superluminescent Diode).

In one non-limiting embodiment, the emitting module 10 further comprises a modulating unit 102 configured to generate a modulated signal 6 for controlling the emission of said initial light beam Fx. In one non-limiting embodiment, the modulated signal 6 is a PWM (Pulse Width Modulation) signal known to those skilled in the art. Of course, other types of modulated signal 6 may be used, such as a PCM (Pulse Code Modulation) signal, a PAM (Pulse Amplitude Modulation) signal or a PPM (Pulse Position Modulation) signal.

In the context of detection of a target object 3, when the initial light beam Fx is emitted, if there are one or more target objects 3 in the field of view of the initial light beam Fx, the initial light beam Fx reflects from the one or more target objects 3 and generates a light beam Fx′. The latter is received by the receiving module 11 of the system 1.

In the context of transmission of data between the motor vehicle 2 and another vehicle or a piece of road infrastructure, the initial light beam Fx is transmitted directly to the receiving module 11. Thus, in this case, the light beam Fx′ received by the receiving module 11 is the initial light beam Fx. In this case, the initial light beam Fx transports a data sequence D (illustrated in FIG. 2) that will be used for communication between the motor vehicle 2 and another vehicle 4 or a piece of road infrastructure. It thus makes it possible to perform its photometric function f, but also to transport the data sequence.

The receiving module 11 is thus configured to:
receive the light beam Fx′ resulting from the initial light beam Fx.

To this end, as illustrated in FIGS. 1 and 2, the receiving module 11 comprises:
at least two optical elements 110, and
at least one photodetector 111.

The two optical elements 110 are placed in front of said at least one photodetector 111.

The two optical elements 110 are configured to receive the light beam Fx′ and to filter the light beam Fx′ in a wavelength range LP from 435 to 455 nanometers, so as to obtain a light beam Fx′ centered on the blue. They are thus configured to transmit to the photodetector 111 the light beam Fx′ in this wavelength range LP. This makes it possible to focus on the blue light of the light beam Fx′ resulting from the initial light beam Fx, where intensity is greatest with respect to the other components of the white light and of the infrared light.

There being sunlight or ambient light, which together will be referred to as parasitic light, the receiving module 11 will receive this sunlight or this ambient light, the latter also being referred to as environmental light. In non-limiting examples, the ambient light is due to a headlamp of another vehicle or of a train. The light beam Fx′ and the sunlight or ambient light will thus superpose. FIG. 6 illustrates the irradiance spectrum of the sunlight Fxs superposed on the intensity spectrum of the light beam Fx′ resulting from the initial light beam Fx. It will be noted that the x-axis represents wavelength and the y-axis represents relative intensity.

Filtering the light beam Fx′ in the wavelength range from 435 to 455 nanometers makes it possible to filter any sunlight that is not superposed on the blue light having an intensity peak B1 (illustrated in FIG. 6). Thus, the sunlight or ambient light that will subsequently be received by the photodetector(s) 111 described below is decreased. The noise associated with this sunlight or ambient light is thus greatly decreased. Only the noise superposed on the blue light will remain.

In a first non-limiting embodiment of the receiving module 11 illustrated in FIG. 3:
one of the two optical elements 110 comprises a first lens 110.1 and an associated low-pass filter 110.2,
the other of the two optical elements 110 comprises a second lens 110.3 and an associated high-pass filter 110.4.

The low-pass filter 110.2 is configured to block the light beam Fx′ in a first wavelength range L. In one non-limiting embodiment, the first wavelength range L is between 455 nanometers and 650 nanometers. Thus, the low-pass filter 110.2 blocks long wavelengths in the light beam Fx′.

The high-pass filter 110.4 is configured to block the light beam Fx′ in a second wavelength range L′. In one non-limiting embodiment, the second wavelength range L′ is between 380 nanometers and 435 nanometers. Thus, the high-pass filter 110.3 blocks short wavelengths in the light beam Fx′.

It will be noted that the first wavelength range L and the second wavelength range L′ do not overlap. This is much simpler to achieve and to optimize than if the two wavelength ranges overlap. The fact that the wavelength ranges are not too wide makes production of the filters less complex, in contrast to a “wider” filter.

In one non-limiting embodiment, the low-pass filter 110.2 and the high-pass filter 110.4 are each a conventional optical flat with two parallel faces. As illustrated in the non-limiting example of FIG. 3, the first lens 110.1 and the associated low-pass filter 110.2 are placed closer to the outer lens 15 and the second lens 110.3 and the associated high-pass filter 110.4 are placed further away, the two low-pass 110.2 and high-pass 110.4 filters being placed between the two lenses 110.1 and 110.4. It will be noted that this arrangement could be reversed, namely the second lens 110.3 and the associated high-pass filter 110.4 could be placed closer to the outer lens 15 and the first lens 110.1 and the associated low-pass filter 110.2 could be placed further away. In one non-limiting embodiment, the first lens 101.1 and the second lens 101.3 are biconvex lenses. It will be noted that plano-convex lenses would also work.

In a second non-limiting embodiment of the receiving module 11 illustrated in FIG. 4:
one of the optical elements 110 is a first lens 110.5 having a high-pass spectral absorption property,
the other of the optical elements 110 is a second lens 110.6 having a low-pass spectral absorption property.

The first lens 110.5 is configured to block the light beam Fx′ in the first wavelength range L. In one non-limiting embodiment, the first wavelength range L is between 455 nanometers and 650 nanometers. Thus, the first lens 110 blocks long wavelengths in the light beam Fx′.

The second lens 110.6 is configured to block the light beam Fx′ in the second wavelength range L′. In one non-limiting embodiment, the second wavelength range L′ is between 380 nanometers and 435 nanometers. Thus, the second lens 110 blocks short wavelengths in the light beam Fx′.

In one non-limiting embodiment, the first lens 110 and the second lens 110 are injection-molded lenses made of an absorption glass that is absorptive in its bulk.

In one non-limiting embodiment, the absorbent material of the first lens 110.5 is a tinted glass selected so it has a transmission coefficient of at least 80% in the first wavelength range L, and a transmission coefficient of less than 80% outside of the first range. It will be noted that outside of the first range, the goal is to get as close to 0% as possible.

In one non-limiting embodiment, the absorbent material of the second lens 110.6 is a tinted glass selected so it has a transmission coefficient of at least 80% in the second wavelength range L′, and a transmission coefficient of less than 80% outside of this second range. It will be noted that outside of the second range, the goal is to get as close to 0% as possible.

As illustrated in the non-limiting example of FIG. 4, the first lens 110.5 is placed closer to the outer lens 15, while the second lens 110.6 is placed further away. It will be noted that this arrangement could be reversed.

Thus, ultimately, by blocking long wavelengths and short wavelengths, the two optical elements 110 according to the first non-limiting embodiment, or according to the second non-limiting embodiment, together allow the light beam Fx′ to be filtered in the wavelength range of blue light between 435 and 455 nanometers, so as to obtain a light beam Fx′ centered on the blue light, or in other words a centered light beam Fx′. It will be noted that filtering between 435 and 455 nanometers according to these two non-limiting embodiments is less expensive than filtering between 435 and 1000 nanometers, i.e. filtering into the infrared.

The centered light beam Fx′ is transmitted to the photodetector(s) 111.

The photodetector 111 is thus configured to receive the light beam Fx′ centered on the blue light from the two optical elements 110.

In one non-limiting embodiment, the receiving module 11 comprises a plurality of photodetectors 111. In one non-limiting embodiment, each photodetector is a SPAD (Single Photon Avalanche Diode). Thus, the avalanche photodiodes may together form a SiPM (Silicon PhotoMultiplier). This non-limiting embodiment of the photodiode will be considered by way of a non-limiting example in the remainder of the description.

The photodiode 111 is a matrix-array of pixels. In the context of detection of a target object 3, based on the received centered light beam Fx′, the photodiode 111 will image the target object 3 in its image focal plane. In one non-limiting embodiment, the photodiode 111 is placed in the image focal plane of the receiving module 11. This makes it possible to accurately detect the one or more target objects 3 located in the field of view of the initial light beam Fx.

When the sunlight or ambient light in the vicinity of the motor vehicle 2 is particularly bright, as seen above, the sunlight or ambient light received by the photodiode 111 sums with the light beam Fx′ received by the receiving module 11, in the blue.

Consequently, if the photodiode 111 of the receiving module 11 receives light other than the blue light resulting from the filtering by the two optical modules 110, it risks being saturated by this other light, in particular if said other light is very bright. It will be recalled that sunlight also contains near-infrared, infrared and UV light. It will be recalled that infrared wavelengths are located between 655 and 1000 nm. In order to eliminate the remaining noise due to parasitic light around the centered light beam Fx′, the photodiode 111 is made insensitive to the infrared, as described below. It will be noted that the UV is filtered by way of the outer lens 15, which comprises an anti-UV treatment in one non-limiting embodiment.

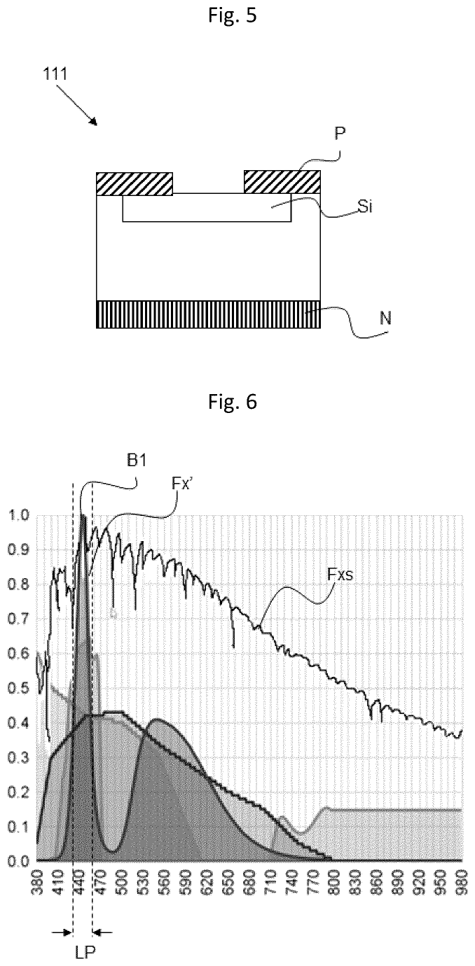

It will be recalled that a photodiode conventionally comprises a PN junction (illustrated in FIG. 5) and the PN junctions are grown epitaxially on a silicon substrate Si (illustrated in FIG. 5). The silicon substrate is conventionally transparent to infrared but opaque to visible light and blue light, i.e. it in particular absorbs blue photons and does not let blue light pass.

To increase the sensitivity of the photodiode 111 to blue light and therefore to make it insensitive to the infrared, in a first non-limiting embodiment the PN junction is placed close to the silicon substrate Si, this amounting to thinning the silicon substrate Si so as to let blue photons pass to the PN junction. Thus, the spectral sensitivity of the photodiode 111 is adjusted depending on the position of the PN junction with respect to the silicon substrate Si. The closer the PN junction is to the silicon substrate Si, the fewer blue photons will be filtered by the silicon substrate Si. As the silicon substrate Si is thinned, it becomes more transparent to blue light and therefore more opaque to infrared light. Thus, the photodiode 111 has a maximum sensitivity at blue wavelengths.

It will be noted that a PN junction far from the silicon substrate Si will be more sensitive in the infrared. In one non-limiting embodiment, the photodiode 111 comprises a PN junction with a bandgap of between 3 electronvolts and 2.5 electronvolts. In one non-limiting embodiment variant, it is about 2.6 electronvolts. This makes it possible to obtain a PN junction close to the surface of the silicon substrate Si. In one non-limiting embodiment, to obtain such a band gap of about 2.6 electronvolts, the photodiode is composed of aluminum arsenide or of gallium-indium nitride. It will be noted that, to obtain spectral sensitivity in the infrared, a bandgap of about 1.8 electronvolts, corresponding to the infrared, which extends from 655 nanometers, would be employed.

Therefore, by virtue of the PN junction close to the silicon substrate Si, the photodiode 111 may be made very sensitive to blue light and insensitive to infrared light, and thus satisfactorily capture the centered light beam Fx′ transmitted by the optical receiving module 11 and capture very little infrared-containing sunlight or ambient light. Thus, neither visible light from the sun or of ambient light, nor the infrared from the sun or of ambient light is able to saturate the photodiode 111. It remains insensitive to wavelengths corresponding to parasitic light. The signal-to-noise ratio is not decreased, but on the contrary is maximized. Thus, the parasitic light will not interfere with acquisition of the centered light beam Fx′ by the photodiode 111.

In a second non-limiting embodiment, the silicon substrate Si is omitted. It is removed using a laser-etching process or a grinding process known to those skilled in the art. This makes it possible to obtain the same result as in the first non-limiting embodiment, namely a maximization of the sensitivity of the photodiode 111 to blue light and a minimization of its sensitivity to other types of light such as infrared light.

The photodetector 111 is configured to convert the centered light beam Fx′ that it received into a corresponding electrical signal 7. The electrical signal 7 is analog or digital.

The receiving module 11 further comprises a demodulating unit 112 configured to demodulate the electrical signal 7.

In the context of detection of a target object 3, the receiving module 11 transmits the demodulated electrical signal 7′ to a computing unit 12 of the system 1 as illustrated in FIG. 1.

The computing unit 12 analyses it and correlates it with the modulated signal 6 seen previously. The correlation allows the computing unit 12 to determine a time of flight separating the emission of the initial light beam Fx and the reception of the light beam Fx′ and thus to deduce the presence or absence of a target object 3 in the field of vision of the initial light beam Fx.

In one non-limiting embodiment, the computing unit 12 is an ECU (Electronic Control Unit) 12. It will be noted that the electronic control unit 12 comprises one or more processors.

In non-limiting embodiments, said correlation is based on:
an accumulation method m based on a histogram of the distribution of photons in the demodulated electronic signal 7′, or
a detection coincidence method m′ based on detection of a number of photons in said demodulated electronic signal 7′ over a duration of one bit. Since the accumulation method and the coincidence method are known to those skilled in the art, they are not described here.

In the context of communication with another vehicle 4 or a piece of road infrastructure, during the demodulation of the electrical signal 7, the receiving module 11 extracts the data sequence D therefrom and transmits it to a computer 13 of the motor vehicle 2, such as illustrated in FIG. 2, so that it may be interpreted, decoded and/or transmitted to a piece of equipment or to a user interface of the motor vehicle 2.

Of course, the description of the invention is not limited to the embodiments described above and to the field described above.

Thus, the described invention in particular has the following advantages:
it replaces ultrasound-based detecting systems,
it allows transmission of an electrical signal by a photodetector 111 of the receiving module 11 to be made reliable, even in the presence of sunlight or of ambient light,
it is a solution that may be used for near-field detection in ADAS (Advanced Driver-Assistance Systems) for providing assistance with parking or for providing assistance during traffic jams in non-limiting examples,
it makes it possible to obtain level 3 vehicle autonomy, which level requires there to be three sensors of different types for safety reasons. It thus allows an additional sensor to be provided, in addition to conventional lidars and conventional radars,
it is a simpler and cheaper solution than interference-based systems, which use a stack of more than 100 layers of various materials with various refractive indices,
the two optical modules 111 of the receiving module 11 make it possible to obtain efficient filtering of blue light in a simple and inexpensive manner,
it makes it possible to make the photodetector(s) 110 insensitive to infrared in a simple manner.

What is claimed is:

1. A system for a vehicle, the system comprising:
a module for receiving a light beam, the receiving module includes at least one photodetector,
wherein:
the receiving module includes at least two optical elements configured to:
receive the light beam, the light beam resulting from an initial light beam generated by an emitting module;
block the light beam in a first wavelength range and in a second wavelength range; and
transmit the light beam to at least one photodetector in a wavelength range between 435 and 455 nanometers,
and in that:
the at least one photodetector is arranged so as to have a maximum sensitivity at blue wavelengths and is configured to receive the light beam in the wavelength range and to convert it into a corresponding electrical signal.

2. The system as claimed in claim 1, wherein the at least one photodetector includes a PN junction with a bandgap of between 3 electronvolts and 2.5 electronvolts.

3. The system as claimed in claim 1, wherein:
one of the optical elements includes a first lens and an associated low-pass filter that is configured to block the light beam in the first wavelength range, and
the other of the optical elements includes a second lens and an associated high-pass filter that is configured to block the light beam in the second wavelength range.

4. The system as claimed in claim 1, wherein:
one of the optical elements is a first lens having a high-pass spectral absorption property configured to block the light beam in the first wavelength range, and
the other of the optical elements is a second lens having a low-pass spectral absorption property configured to filter the light beam in the second wavelength range.

5. The system as claimed in claim 1, wherein the first wavelength range is between 455 nanometers and 650 nanometers.

6. The system as claimed in claim 1, wherein the second wavelength range is between 380 nanometers and 435 nanometers.

7. The system as claimed in claim 1, wherein the system further comprises an emitting module including a luminous module configured to emit the initial light beam partly in the visible.

8. The system as claimed in claim 7, wherein the emitting module includes a modulating unit configured to generate a modulated signal for controlling the emission of the initial light beam.

9. The system as claimed in claim 7, wherein the luminous module includes at least one light source configured to emit the initial light beam with a view to performing a photometric lighting and/or signaling or daytime-running-light function.

10. The system as claimed in claim 7, wherein the emitting module forms part of a headlamp or tail lamp of the vehicle.

11. The system as claimed in claim 1, wherein the light beam is a light beam reflected from at least one target object located in a field of view of the initial light beam.

12. The system as claimed in claim 11, wherein the receiving module includes a demodulating unit configured to demodulate the electrical signal and to transmit the demodulated electrical signal to a computing unit, and wherein the computing unit is configured, based on the demodulated electrical signal, to correlate the demodulated electrical signal and the modulated signal in order to deduce therefrom the presence of the at least one target object.

13. The system as claimed in claim 7, wherein the emitting module forms part of another vehicle or of a piece of road infrastructure.

14. The system as claimed in claim 13, wherein the light beam transports a data sequence.

15. The system as claimed in claim 14, wherein the receiving module includes a demodulating unit configured to demodulate the electrical signal and to extract therefrom the data sequence with a view to using it for communication with other vehicle the piece of road infrastructure.
